(19) United States
(12) Patent Application Publication
(10) Pub. No.: US 2025/0288981 A1
(43) Pub. Date: Sep. 18, 2025

(54) CATALYST PELLETS THAT INCLUDE POLYGONAL PRISMATIC BODIES, PACKED BED REACTORS INCLUDING THE SAME, AND METHODS FOR HYDROPROCESSING UTILIZING THE SAME

(71) Applicant: Saudi Arabian Oil Company, Dhahran (SA)

(72) Inventors: Maher Maqbool Shariff, Dhahran (SA); Hana Hashim Al-Habboubi, Khobar (SA); Jamal H. Al-Smail, Dhahran (SA); Lianhui Ding, Dhahran (SA); Olanrewaju Malcolm Oshinowo, Dhahran (SA)

(73) Assignee: Saudi Arabian Oil Company, Dhahran (SA)

(21) Appl. No.: 18/603,579

(22) Filed: Mar. 13, 2024

(51) Int. Cl. B01J 35/50; B01J 8/02; B01J 29/04; B01J 35/40; C10G 49/04

(52) U.S. Cl. CPC B01J 35/50; B01J 8/02; B01J 29/04; B01J 35/40; C10G 49/04

(57) ABSTRACT

Embodiments herein are directed to a catalyst pellet including a substantially regular polygonal prismatic body including a first polygonal surface, a second polygonal surface opposite the first polygonal surface, and n faces each extending in a length dimension from the first polygonal surface to the second polygonal surface, where n is equal to an integer from 5 to 20. The catalyst pellet includes n apertures extending from the first polygonal surface to the second polygonal surface. Each aperture has a substantially cylindrical shape and is positioned such that it is oriented towards a corner of the first polygonal surface and the second polygonal surface. Further embodiments are directed to a packed bed reactor including a reactor vessel and a packed catalyst bed including at least one catalyst pellet described herein. Further embodiments are directed to a method for hydroprocessing a hydrocarbon feed including passing the hydrocarbon feed into a reactor vessel, such that the hydrocarbon feed contacts a packed catalyst bed including at least one catalyst pellet described herein to form a product composition and passing the product composition out of the reactor vessel.

### TECHNICAL FIELD

Embodiments of the present disclosure generally relate to catalysts and, more specifically, to catalyst pellets for use in chemical processing.

### BACKGROUND

Catalysts are important components used to increase the rate of chemical reactions. Catalysts are utilized in wide variety of reactions in the industry, including but not limited to, hydroprocessing. Some catalysts are utilized in packed beds and, generally, these catalysts may be formed in particular geometries. The shape of the catalyst pellets may affect the activity of the catalyst in the reaction. As such, new catalyst pellet geometries that may enhance product yields are desired by industry.

### SUMMARY

It is generally desired for catalysts to have a relatively high surface area to volume ratio in order to provide more active sites on which a reaction may take place. However, increased surface area may diminish structural integrity, which may lead to the need for more catalyst inventory to be utilized as catalyst pellets are degraded during normal use. Accordingly, there is a need for catalyst pellet geometries that enhance catalyst activity in catalytic reactions by having relatively high surface area to volume ratio while maintaining a suitable structural integrity. It has been presently discovered that catalysts in the shape of polygonal prism with apertures traversing through the polygonal prism, as are described in detail herein, may have a larger surface area to volume ratio than typical catalyst pellet shapes, such as spherical, cylindrical, trilobed, or tetralobed catalysts, while also maintaining an acceptable structural integrity.

According to embodiments described herein, a catalyst pellet may comprise a substantially regular polygonal prismatic body. The polygonal prismatic body may comprise a first polygonal surface, a second polygonal surface opposite the first polygonal surface, and n faces each extending in a length dimension from the first polygonal surface to the second polygonal surface, wherein n may be equal to an integer from 5 to 20. The catalyst pellet may comprise n apertures extending from the first polygonal surface to the second polygonal surface. Each aperture may have a substantially cylindrical shape, and each aperture may be positioned such that it is oriented towards a corner of the first polygonal surface and the second polygonal surface.

According to additional embodiments described herein, a packed bed reactor may comprise a reactor vessel comprising an inlet and an outlet and a packed catalyst bed comprising at least one catalyst pellet. The catalyst pellet may comprise a substantially regular polygonal prismatic body. The polygonal prismatic body may comprise a first polygonal surface, a second polygonal surface opposite the first polygonal surface, and n faces each extending in a length dimension from the first polygonal surface to the second polygonal surface, wherein n may be equal to an integer from 5 to 20. The catalyst pellet may comprise n apertures extending from the first polygonal surface to the second polygonal surface. Each aperture may have a substantially cylindrical shape, and each aperture may be positioned such that it is oriented towards a corner of the first polygonal surface and the second polygonal surface.

According to additional embodiments described herein, a method for hydroprocessing a hydrocarbon feed may comprise passing the hydrocarbon feed into a reactor vessel in the presence of hydrogen, such that the hydrocarbon feed contacts a packed catalyst bed to form a product composition. The packed catalyst bed may comprise at least one catalyst pellet. The catalyst pellet may comprise a substantially regular polygonal prismatic body. The polygonal prismatic body may comprise a first polygonal surface, a second polygonal surface opposite the first polygonal surface, and n faces each extending in a length dimension from the first polygonal surface to the second polygonal surface, wherein n may be equal to an integer from 5 to 20. The catalyst pellet may comprise n apertures extending from the first polygonal surface to the second polygonal surface. Each aperture may have a substantially cylindrical shape, and each aperture may be positioned such that it is oriented towards a corner of the first polygonal surface and the second polygonal surface. The method may comprise passing the product composition out of the reactor vessel.

These and other embodiments are described in more detail in the Detailed Description. It is to be understood that both the foregoing general description and the following detailed description present embodiments of the subject technology, and are intended to provide an overview or framework for understanding the nature and character of the described technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently described technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where the structure is indicated with like reference numerals and in which:

FIG. 1A schematically depicts a perspective view of a catalyst pellet, according to one or more embodiments described in this disclosure;

FIG. 1B schematically depicts a front view of the catalyst pellet of FIG. 1A, according to one or more embodiments described in this disclosure;

FIG. 1C schematically depicts a side view of the catalyst pellet of FIG. 1A, according to one or more embodiments described in this disclosure;

FIG. 1D schematically depicts a front view of another catalyst pellet, according to one or more embodiments described in this disclosure;

FIG. 1E schematically depicts a front view of another catalyst pellet, according to one or more embodiments described in this disclosure;

FIG. 1F schematically depicts a front view of another catalyst pellet, according to one or more embodiments described in this disclosure;

FIG. 2A schematically depicts a front view of another catalyst pellet, according to one or more embodiments described in this disclosure;

FIG. 2B schematically depicts a side view of the catalyst pellet of FIG. 2A, according to one or more embodiments described in this disclosure; and

FIG. 2C schematically depicts a front view of another catalyst pellet, according to one or more embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

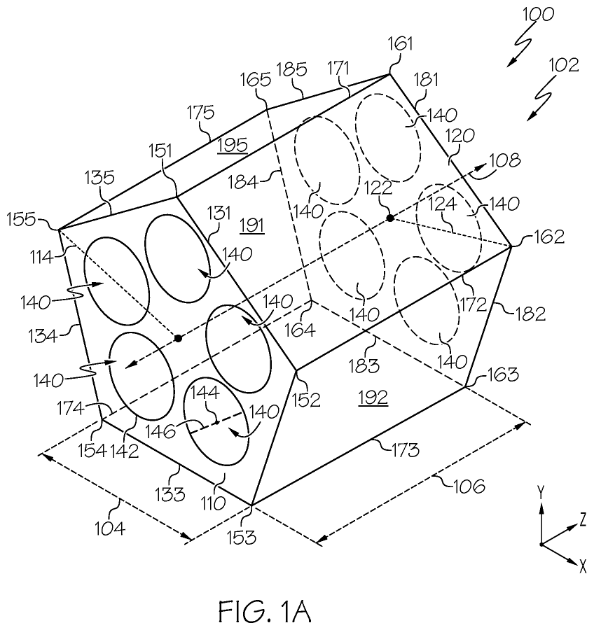

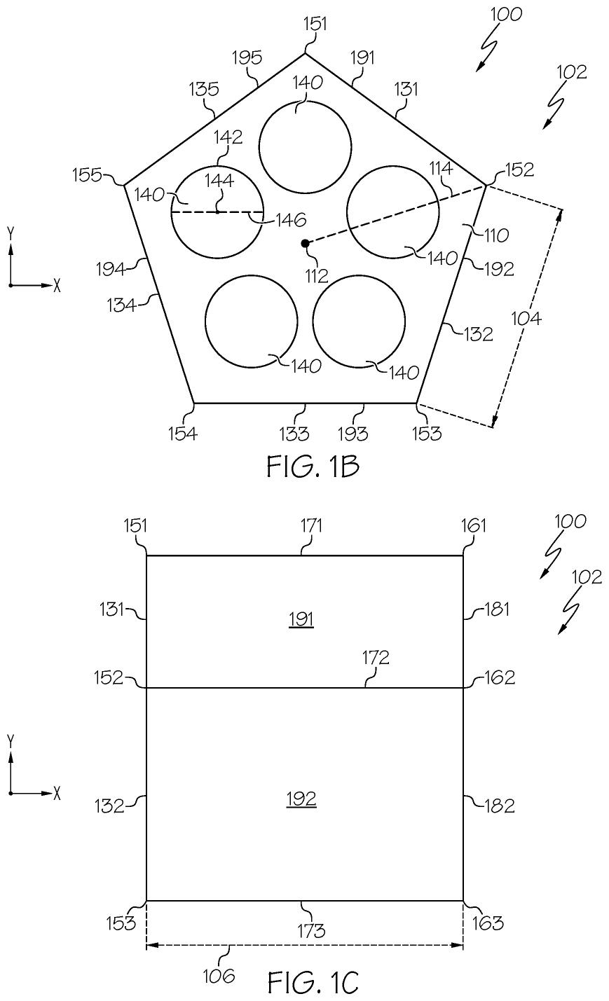

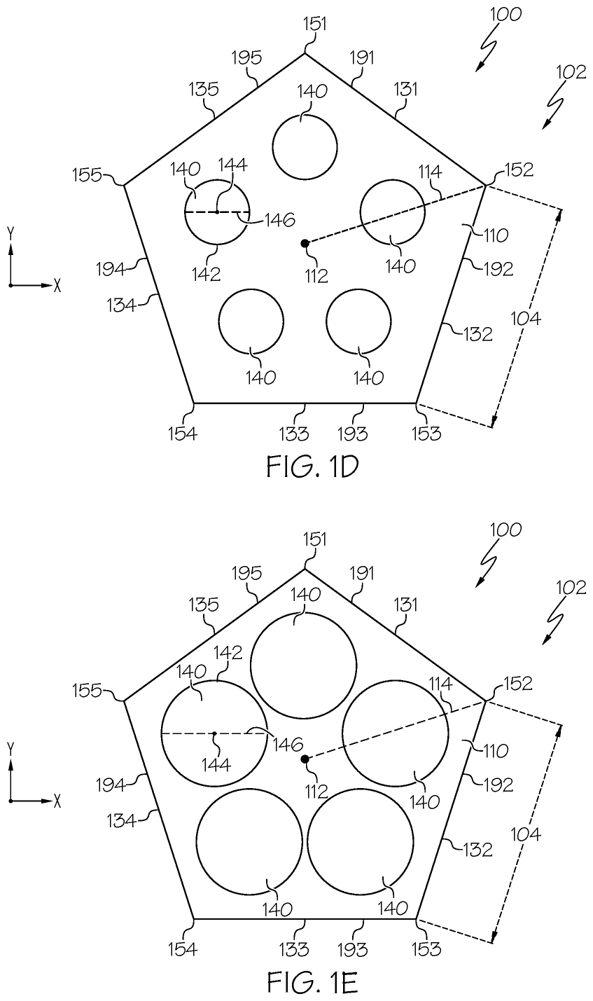

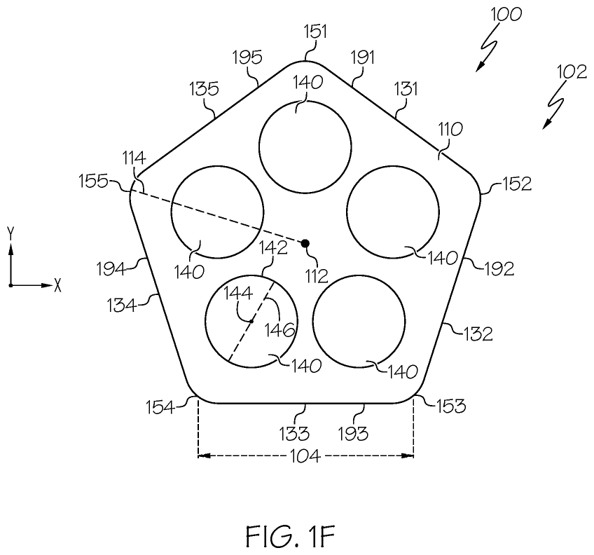

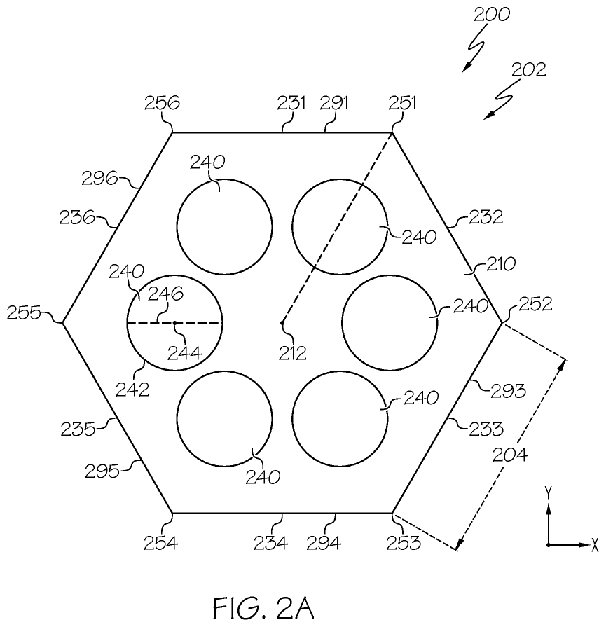

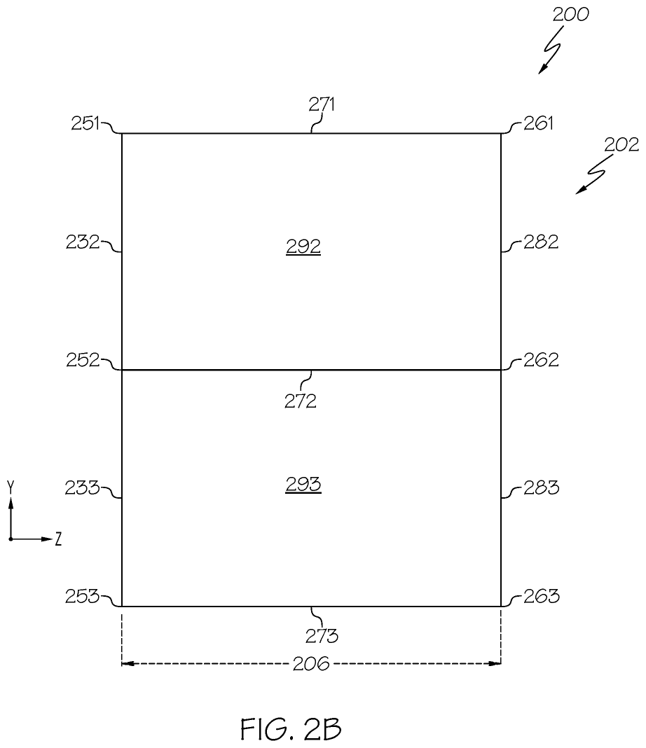

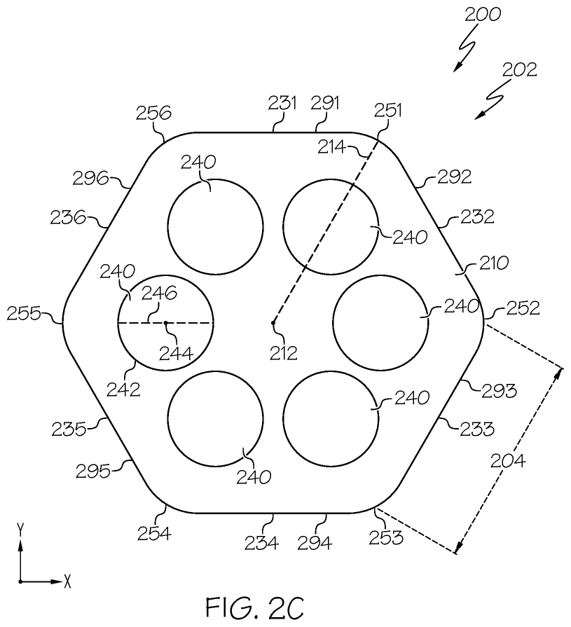

Embodiments of the present disclosure relate to catalyst pellets for use in chemical processing. The embodiments of FIGS. 1 and 2 are similar or identical in many ways, respectively, but include differences as described herein. Descriptions of the embodiments of FIGS. 1 and 2 may generally apply to the embodiments of the other figures, as would be understood by those skilled in the art. For example, concepts disclosed herein applicable to FIG. 1 may be equally applicable to FIG. 2 and vice versa, even if not explicitly stated as such herein.

As used in this disclosure, a “catalyst” refers to any substance which increases the rate of a specific chemical reaction. Catalysts described in this disclosure may be utilized to promote various reactions, such as, but not limited to, hydroprocessing reactions including hydrotreating and hydrocracking.

Now referring to FIGS. 1A, 1B, and 1C, a catalyst pellet 100 is depicted. In particular, FIG. 1A is a perspective view of a catalyst pellet 100, FIG. 1B is a side view of the catalyst pellet 100, and FIG. 1C is a side view of the catalyst pellet 100. As is described, the catalyst pellet 100 of FIGS. 1A, 1B, and 1C is a normal pentagonal prism.

The catalyst pellet 100 may comprise a polygonal prismatic body 102 and n apertures 140, wherein in the embodiment of FIG. 1A, there are five apertures 140. As used herein, the term “polygonal prismatic body” may refer to a three-dimensional polygonal prism made from two polygonal surfaces 110, 120 connected by rectangular faces 191, 192, 193, 194, 195 extending between the two polygonal surfaces 110, 120. As shown in FIG. 1A, in some embodiments, the polygonal prismatic body 102 may be a pentagonal prism having two pentagonal surfaces, a first polygonal surface 110 and a second polygonal surface 120, and five faces 191, 192, 193, 194, 195. In some embodiments, n may equal an integer from 5 to 20, such that the polygonal prismatic body 102 has n faces, the first polygonal surface 110 is a polygon with n sides 131, 132, 133, 134, 135, and the second polygonal surface 120 is a polygon with n sides 181, 182, 183, 184, 185. In some embodiments, n may equal an integer from 5 to 6, from 6 to 8, from 8 to 10, from 10 to 15, from 15 to 20, or any combination of these ranges.

In general, the catalyst pellets 100 may have a geometry that is described as “substantially” regular polygonal prismatic. This is, the geometry of the catalyst pellets 100 may be slightly non-regular and/or slightly non-prismatic. As described herein, substantially refers to geometries whereby each measurement of any side of any surface is within 10% (or 5%, or 2%, or 1%, in some additional embodiments) of the size of a mathematically precise regular polygonal prism. Such a calculation may be readily conducted by those skilled in the art.

According to one or more embodiments, the polygonal prismatic body 102 may comprise a first polygonal surface 110 and a second polygonal surface 120 opposite the first polygonal surface 110. The second polygonal surface 120 may be a translation of the first polygonal surface 110 across the z-axis, as shown in FIG. 1A. As used herein, a “translation” refers to a geometric movement that moves every point of a shape by the same distance in a given direction such that the shapes are identical to each other, such that the first polygonal surface 110 and a second polygonal surface 120 have the substantially the same size and shape. In one or more embodiments, the first polygonal surface 110 and the second polygonal surface 120 may be substantially regular polygons. As used herein, a “regular polygon” refers to a polygon with congruent sides and equal angles.

Now referring to FIG. 1B, a front view of a catalyst pellet 100 is schematically depicted. The first polygonal surface 110 may comprise n sides, including a first side 131, a second side 132, a third side 133, a fourth side 134, and a fifth side 135. In one or more embodiments, the first polygonal surface 110 may be substantially normal, such that they are substantially radially symmetric, such that the sides 131, 132, 133, 134, 135 have about an equal width dimension 104. As used herein, “radially symmetric” refers to symmetry around the central axis 108. In some embodiments, the width dimension 104 may be from 1 mm to 6 mm. For example, and in some embodiments, the width dimension 104 may be from 1 mm to 2 mm, from 2 mm to 3 mm, from 3 mm to 4 mm, from 4 mm to 5 mm, from 5 mm to 6 mm, or any combinations of these ranges.

Generally, the polygonal prismatic body 102 may comprise n faces 191, 192, 193, 194, 195 in the embodiment of FIG. 1A, where n is an integer from 5 to 20. The polygonal prismatic body 102 may have a first face 191, a second face, 192, a third face 193, a fourth face 194, and a fifth face 195. In embodiments, the faces 191, 192, 193, 194, 195 may be rectangles. The number of faces 191, 192, 193, 194, 195 may determine the polygonal shape of the first polygonal surface 110 and the second polygonal surface 120. For example, in one or more embodiments, n may equal 5, such that the polygonal prismatic body 102 has five faces 191, 192, 193, 194, 195, and the first polygonal surface 110 and the second polygonal surface 120 are pentagons.

Now referring to FIG. 1C, a side view of a catalyst pellet 100 is schematically depicted. In some embodiments, the faces 191, 192, 193, 194, 195 may extend in a length dimension 106 from the first polygonal surface 110 to the second polygonal surface 120. In some embodiments, the length dimension 106 may be from 1 mm to 10 mm, such as from 2 mm to 8 mm, from 3 mm to 7 mm, from 4 mm to 6 mm, or any combinations of these ranges. In some embodiments, the length dimension 106 may be 5 mm.

Now referring back to FIG. 1A, according to one or more embodiments, the ratio of the width dimension 104 to the length dimension 106 may be from 0.1 to 6. For example, in some embodiments, the ratio of the width dimension 104 to the length dimension 106 may be from 0.1 to 1, from 1 to 2, from 2 to 3, from 3 to 4, from 4 to 5, from 5 to 6, or any combinations of these ranges. In some embodiments, the ratio of the width dimension 104 to the length dimension 106 may be from 0.1 to 1. For example, in some embodiments, the ratio of the width dimension 104 to the length dimension 106 may be from 0.1 to 0.2, from 0.2 to 0.3, from 0.3 to 0.4, from 0.4 to 0.5, from 0.5 to 0.6, from 0.6 to 0.7, from 0.7 to 0.8, from 0.9 to 1, or any combinations of these ranges.

Still referring to FIG. 1A, in some embodiments, the faces 191, 192, 193, 194, 195 may connect at edges 171, 172, 173, 174, 175. For example, the fifth face 195 and the first face 191 may connect at a first edge 171. Similarly, the first face 191 and the second face 192 may connect at a second edge 172. The edges 171, 172, 173, 174, 175 may extend in the length dimension 106 from the corners 151, 152, 153, 154, 155 of the first polygonal surface 110 to the corners 161, 162, 163, 164, 165 of the second polygonal surface 120. The corners 151, 152, 153, 154, 155 and the corners 161, 162, 163, 164, 165 may be a sharp vertex, such that the edges 171, 172, 173, 174, 175 are sharp.

In one or more embodiments, the circumradius 114 of the first polygonal surface 110 and the circumradius 124 of the second polygonal surface 120 may be from 1 mm to 5 mm. As used herein, the term “circumradius” refers to the radius of a circle that passes through all corners of a regular polygon. For example, in some embodiments, the circumradius 114 of the first polygonal surface 110 and the second polygonal surface 120 may be from 1 mm to 2 mm, from 2 mm to 3 mm, from 3 mm to 4 mm, from 4 mm to 5 mm, or any combinations of these ranges. In some embodiments, the circumradius 114 of the first polygonal surface 110 and the second polygonal surface 120 may be from 1.5 mm to 4.5 mm, from 2 mm to 4 mm, from 2.5 mm to 3.5 mm, or any combinations of these ranges. In some embodiments, the circumradius 114 may be 3 mm. Referring to FIG. 1A, in some embodiments, the circumradius 114 may refer to the distance from a corner 151, 152, 153, 154, 155 of the first polygonal surface 110 to the center point 112 of the first polygonal surface 110. In some embodiments, the circumradius 124 may refer to the distance from a corner 161, 162, 163, 164, 165 of the second polygonal surface 120 to the center point 122 of the second polygonal surface 120. In some embodiments, the circumradius 114 and the circumradius 124 are equal.

According to one or more embodiments, the catalyst pellet 100 may comprise n apertures 140 extending from the first polygonal surface 110 to the second polygonal surface 120. As used herein, the term “aperture” refers to a hole that traverses through the catalyst pellet 100 substantially parallel to the central axis 108. In one or more embodiments, each aperture 140 may have a substantially cylindrical shape, such that each aperture 140 has a substantially circular cross-sectional shape in a plane perpendicular to the central axis 108. In some embodiments, each aperture 140 may comprise an aperture side wall 142 that is substantially circular. In one or more embodiments, n may be equal to an integer from 5 to 20, where the number of apertures 140 is identical to the number of faces 191, 192, 193, 194, 195. For example, in some embodiments, n may equal 5 such that the catalyst pellet 100 has five apertures 140.

In one or more embodiments, each aperture 140 may be positioned such that it is oriented towards a corner 151, 152, 153, 154, 155 of the first polygonal surface 110 and the respective corner 161, 162, 163, 164, 165 of the second polygonal surface 120. In some embodiments, the apertures 140 may be substantially radially symmetric with respect to the first polygonal surface 110 and the second polygonal surface 120. The apertures 140 may be substantially radially symmetric around the central axis 108. In some embodiments, the apertures 140 may be substantially equidistant from each other such that the centers 144 of the apertures 140 are substantially the same distance from one another.

Referring now to FIGS. 1B, 1D, and 1E, according to embodiments, the apertures 140 may vary in size. For example, FIG. 1D shows an embodiment with apertures 140 smaller than that of the embodiment of FIG. 1B, and FIG. 1E shows an embodiments with apertures 140 larger than that of the embodiment of FIG. 1B. According to embodiments, the apertures 140 may have a diameter 146 of from 1 mm to 2 mm. For example, and in some embodiments, the apertures 140 may have a diameter 146 of from 1 mm to 1.25 mm, from 1.25 mm to 1.5 mm, from 1.5 mm to 1.75 mm, from 1.75 mm to 2 mm, or any combinations of these ranges. Without being limited by theory, it is believed that apertures 140 with diameters less than 1 mm or greater than 2 mm will cause the catalyst pellet 100 to have poor surface area to volume ratio and/or poor structural integrity.

Now referring to FIG. 1F, in additional embodiments, the corners 151, 152, 153, 154, 155 of the first polygonal surface 110 and the corners 161, 162, 163, 164, 165 of the second polygonal surface 120 may be rounded, such that the edges 171, 172, 173, 174, 175 are also rounded. Without being limited by theory, rounding the corners may reduce deformation and improve the strength and/or durability of the catalyst pellet 100 during the reaction.

Now referring to FIGS. 2A, 2B, and 2C, a hexagonal prismatic body for a catalyst pellet 200 is depicted. In such embodiments, n may equal 6, such that the polygonal prismatic body 102 may be a hexagonal prism having two hexagonal surfaces, a first polygonal surface 210 and a second polygonal surface 220 (not shown), and six faces 291, 292, 293, 294, 295, 296. The polygonal prismatic body 202 may have a first face 291, a second face, 292, a third face 293, a fourth face 294, a fifth face 295, and a sixth face 296. In some embodiments, the faces 291, 292, 293, 294, 295, 296 may be rectangles.

In one or more embodiments, the first polygonal surface 210 may comprise six sides, a first side 231, a second side 232, a third side 233, a fourth side 234, a fifth side 235, and a sixth side 236. Although not shown, the second polygonal surface 210 may also comprise six sides, a first side 281, a second side 282, a third side 283, a fourth side 284, a fifth side 285, and a sixth side 286. In one or more embodiments, the first polygonal surface 210 may be substantially normal, such that they are substantially radially symmetric, such that the sides 231, 262, 233, 234, 235, 236 have about an equal width dimension 204. In some embodiments, the width dimension 104 may be from 1 mm to 6 mm. For example, and in some embodiments, the width dimension 204 may be from 1 mm to 2 mm, from 2 mm to 3 mm, from 3 mm to 4 mm, from 4 mm to 5 mm, from 5 mm to 6 mm, or any combinations of these ranges.

Now referring to FIG. 2B, a side view of a catalyst pellet 200 is schematically depicted. In some embodiments, the faces 292, 293 (and 291, 294, 295, 295 not shown) may extend in a length dimension 206 from the first polygonal surface 210 to the second polygonal surface 220. In some embodiments, the length dimension 206 may be from 1 mm to 10 mm, such as from 2 mm to 8 mm, from 3 mm to 7 mm, or from 4 mm to 6 mm. In some embodiments, the length dimension 206 may be 5 mm.

According to one or more embodiments, the ratio of the width dimension 204 to the length dimension 206 may be from 0.1 to 6. For example, in some embodiments, the ratio of the width dimension 204 to the length dimension 206 may be from 0.1 to 1, from 1 to 2, from 2 to 3, from 3 to 4, from 4 to 5, from 5 to 6, or any combinations of these ranges. In some embodiments, the ratio of the width dimension 204 to the length dimension 206 may be from 0.1 to 1. For example, in some embodiments, the ratio of the width dimension 204 to the length dimension 206 may be from 0.1 to 0.2, from 0.2 to 0.3, from 0.3 to 0.4, from 0.4 to 0.5, from 0.5 to 0.6, from 0.6 to 0.7, from 0.7 to 0.8, from 0.9 to 1, or any combinations of these ranges.

In some embodiments, the faces 291, 292, 293, 294, 295, 296 may connect at edges 271, 272, 273, 274, 275, 276. For example, as shown in FIG. 2B, the second face 292 and the third face 292 may connect at a second edge 272. Similarly, the third face 293 and the fourth face 294 (not shown) may connect at a third edge 273. The edges 271, 272, 273 (and 274, 275, 276 not shown) may extend in the length dimension 206 from the corners 251, 252, 253, (and 254, 255, 256 not shown) of the first polygonal surface 210 to the corners 261, 262, 263 (and 264, 265, 266 not shown) of the second polygonal surface 220. The corners 251, 252, 253, 254, 255, 256 and the corners 261, 262, 263, 264, 265, 266 may form a sharp vertex, such that the edges 271, 272, 273, 274, 275, 276 may be sharp. Referring now to FIG. 2C, the corners 251, 252, 253, 254, 255, 256 of the first polygonal surface 210 and the corners 261, 262, 263, 264, 265, 266 of the second polygonal surface 220 may be rounded, such that the edges 271, 272, 273, 274, 275, 276 are also rounded.

Referring again to FIG. 2A, in one or more embodiments, the circumradius 214 of the first polygonal surface 210 and the circumradius 224 (not shown) of the second polygonal surface 220 (not shown) may be from 1 mm to 5 mm. For example, in some embodiments, the circumradius 214 of the first polygonal surface 210 and the second polygonal surface 220 may be from 1 mm to 2 mm, from 2 mm to 3 mm, from 3 mm to 4 mm, from 4 mm to 5 mm, or any combinations of these ranges. In some embodiments, the circumradius 214 may refer to the distance from a corner 251, 252, 253, 254, 255, 256 of the first polygonal surface 210 to the center point 212 of the first polygonal surface 210. Although not shown, in some embodiments, the circumradius 224 may refer to the distance from a corner 261, 262, 263, 264, 265, 266 of the second polygonal surface 220 to the center point 222 of the second polygonal surface 220. In some embodiments, the circumradius 214 and the circumradius 224 are equal.

According to one or more embodiments, the catalyst pellet 200 may comprise n apertures 240 extending from the first polygonal surface 210 to the second polygonal surface 220. In one or more embodiments, each aperture 240 may have a substantially cylindrical shape, such that each aperture 240 has a substantially circular cross-sectional shape in a plane perpendicular to the central axis 208. In some embodiments, each aperture 240 may comprise an aperture side wall 242 that is substantially circular. As shown in FIG. 2A, in one or more embodiments, n may equal 6 such that the catalyst pellet 200 comprises six apertures 240.

In one or more embodiments, each aperture 240 may be positioned such that it is oriented towards a corner 251, 252, 253, 254, 255, 256 of the first polygonal surface 210 and a corner 261, 262, 263, 264, 265, 266 of the second polygonal surface 220. In some embodiments, the apertures 240 may be substantially radially symmetric with respect to the first polygonal surface 210 and the second polygonal surface 220. The apertures 240 may be substantially radially symmetric around the central axis 208. In some embodiments, the apertures 240 may be substantially equidistant from each other such that the centers 244 of the apertures 240 are substantially the same distance from one another. In some embodiments, the apertures 240 may have a diameter 246 of from 1 mm to 2 mm. For example, and in some embodiments, the apertures 240 may have a diameter 246 of from 1 mm to 1.25 mm, from 1.25 mm to 1.5 mm, from 1.5 mm to 1.75 mm, from 1.75 mm to 2 mm, or any combinations of these ranges.

Referring now to FIGS. 1A-1F and 2A-2C, according to one or more embodiments, the catalyst pellet 100, 200 may be a bi-functional catalyst. In some embodiments, the catalyst pellet 100, 200 may comprise both a cracking component and a hydrogenation component. The cracking component may comprise one or more of zeolite, alumina, or amorphous silica-alumina. The hydrogenation component may comprise one or more of molybdenum, nickel, tungsten, cobalt, iridium, platinum, or palladium. For example, in some embodiments, the hydrogenation component may comprise MoNi, WNi, MoCo, Pt, Pd, or combinations thereof.

In some embodiments, the catalyst pellet 100, 200 may be formed by bonding catalyst particulates with a binder. In some embodiments, the catalyst particulates may comprise from 0 wt. % to 20 wt. % of Molybdenum (VI) Trioxide (MoO₃). In some embodiments, the catalyst particulates may comprise MoO₃ in an amount from 0 wt. % to 5 wt. %, from 5 wt. % to 10 wt. %, from 10 wt. % to 15 wt. %, from 15 wt. % to 20 wt. %, or any combinations of these ranges. In some embodiments, the catalyst particulates may comprise from 0 wt. % to 30 wt. % of Tungsten (VI) Trioxide (WO₃). In some embodiments, the catalyst particulates may comprise from WO₃ in an amount from 0 wt. % to 5 wt. %, from 5 wt. % to 10 wt. %, from 10 wt. % to 15 wt. %, from 15 wt. % to 20 wt. %, from 20 wt. % to 25 wt. %, from 25 wt. % to 30 wt. %, or any combinations of these ranges. In some embodiments, catalyst particulates may comprise from 0 wt. % to 8 wt. % of Nickel (II) Oxide (NiO). In some embodiments, catalyst particulates may comprise NiO in an amount from 0 wt. % to 2 wt. %, from 2 wt. % to 4 wt. %, from 4 wt. % to 6 wt. %, from 6 wt. % to 8 wt. %, or any combinations of these ranges. In some embodiments, the binder may be Aluminum (III) Oxide (Al₂O₃).

According to one or more embodiments, the catalyst pellet 100, 200 may have a surface area to volume ratio of greater than or equal to 2 mm⁻¹. For example, the catalyst pellet 100, 200 may have a surface area to volume ratio of greater than or equal to 2.2 mm⁻¹, greater than or equal to 2.5 mm⁻¹, greater than or equal to 3 mm⁻¹, greater than or equal to 4 mm⁻¹, or even greater than or equal to 5 mm⁻¹. The catalyst pellet 100, 200 may have a surface area to volume ratio of from 2 to 5.5. It is believed that the catalyst pellets described herein have a larger surface area to volume ratio than typical catalyst pellet shapes, such as spherical, cylindrical, trilobed or tetralobed catalysts.

According to one or more embodiments, the catalyst pellet 100, 200 may be utilized in a packed bed reactor. The packed bed reactor may comprise a reactor vessel comprising an inlet and an outlet and a packed catalyst bed comprising at least one catalyst pellet 100, 200.

According to one or more embodiments, the catalyst pellet 100, 200 may be utilized as a guard bed catalyst in the packed bed reactor. As used in this disclosure, a “guard bed catalyst” is a type of catalyst used in certain processes to remove impurities or contaminants from a process stream before they reach active catalyst beds in hydroprocessing reactors. The hydroprocessing reactors may need to be protected from solids and dissolved contaminants that may plug the downstream active catalysts or cause the active catalysts to be permanently deactivated. In some embodiments, the packed bed reactor may comprise a guard bed fluidly connected to the inlet of the reactor vessel. In some embodiments, the guard bed may comprise at least one catalyst pellet 100, 200.

According to one or more embodiments, the catalyst pellet 100, 200 may be utilized in hydroprocessing reactions. As used in this disclosure, “hydroprocessing” refers to the process in which a hydrocarbon feed is reacted in the presence of hydrogen and one or more hydroprocessing catalysts to produce an upgraded effluent. Hydroprocessing may include hydrotreating and hydrocracking. As used in this disclosure, “hydrotreating” may refer to a process in which impurities such as sulfur, nitrogen, and metals, from a hydrocarbon feed are removed which upgrades the quality of the products and prepares a cleaner feed for units downstream of the hydrotreating process. As used in this disclosure, “hydrocracking” may refer to a catalytic process that converts heavy oils to lighter fractions, primarily by means of aromatic saturation, cracking, and isomerization reactions in the presence of hydrogen and catalysts. In some embodiments, the feed may be a crude oil stream having a API gravity of at least 30 degrees

In some embodiments, a method for hydroprocessing a hydrocarbon feed may include the use of catalyst pellet 100, 200 described herein. The method may comprise passing the hydrocarbon feed into a reactor vessel in the presence of hydrogen, such that the hydrocarbon feed contacts a packed catalyst bed to form a product composition and passing the product composition out of the reactor vessel. In some embodiments, the packed catalyst bed may comprise at least one catalyst pellet 100, 200.

In some embodiments, the hydrocarbon feed may comprise crude oil. As used herein, the term “crude oil” may refer to a raw hydrocarbon material which has not been previously treated, separated, or otherwise refined or may refer to a hydrocarbon material which has undergone some degree of processing, such as treatment, separation, reaction, purifying, or other operation prior to being introduced to the reactor.

In some embodiments, the product composition may comprise transportation fuels, light olefins, aromatic compounds, or combinations thereof. For example, the product composition may comprise diesel fuels, gasoline, ethylene, propene, butene, benzene, toluene, ethylbenzene, xylenes, or combinations thereof.

The present disclosure includes numerous aspects, including aspects 1-20 described herein.
Aspect 1. A catalyst pellet comprising: a substantially regular polygonal prismatic body comprising: a first polygonal surface; a second polygonal surface opposite the first polygonal surface; and n faces each extending in a length dimension from the first polygonal surface to the second polygonal surface, wherein n is equal to an integer from 5 to 20; and n apertures extending from the first polygonal surface to the second polygonal surface, wherein each aperture has a substantially cylindrical shape, and wherein each aperture is positioned such that it is oriented towards a corner of the first polygonal surface and the second polygonal surface.
Aspect 2. The catalyst pellet of aspect 1, wherein the first polygonal surface and the second polygonal surface comprise rounded corners.
Aspect 3. The catalyst pellet of any previous aspect, wherein n=5.
Aspect 4. The catalyst pellet of any previous aspect, wherein n=6.
Aspect 5. The catalyst pellet of any previous aspect, wherein the position of the apertures are substantially radially symmetric with respect to the first polygonal surface and the second polygonal surface.
Aspect 6. The catalyst pellet of any previous aspect, further comprising a cracking component comprising one or more of zeolite, alumina, or amorphous silica-alumina and a hydrogenation component comprising one or more of molybdenum, nickel, tungsten, cobalt, iridium, platinum, or palladium.
Aspect 7. The catalyst pellet of any previous aspect, further comprising from 0 wt. % to 20 wt. % Molybdenum (VI) Trioxide, from 0 wt. % to 30 wt. % of Tungsten (VI) Trioxide, and from 0 wt. % to 8 wt. % of Nickel (II) Oxide.
Aspect 8. The catalyst pellet of any previous aspect, further comprising a surface area to volume ratio of greater than or equal to 2 mm⁻¹.
Aspect 9. The catalyst pellet of any previous aspect, wherein the apertures have a diameter of from 1 mm to 2 mm.
Aspect 10. The catalyst pellet of any previous aspect, wherein the length dimension is from 1 mm to 10 mm.
Aspect 11. The catalyst pellet of any previous aspect, wherein the circumradius of the first polygonal surface and the second polygonal surface is from 1 mm to 5 mm.
Aspect 12. The catalyst pellet of any previous aspect, wherein the ratio of the width dimension to the length dimension is from 0.1 to 6.
Aspect 13. A packed bed reactor comprising: a reactor vessel comprising an inlet and an outlet; a packed catalyst bed comprising at least one catalyst pellet, wherein the catalyst pellet comprises: a substantially regular polygonal prismatic body comprising a first polygonal surface, a second polygonal surface opposite the first polygonal surface, and n faces each extending in a length dimension from the first polygonal surface to the second polygonal surface, wherein n is equal to an integer from 5 to 20; and n apertures extending from the first polygonal surface to the second polygonal surface, wherein each aperture has a substantially cylindrical shape, and wherein each aperture is positioned such that it is oriented towards a corner of the first polygonal surface and the second polygonal surface.
Aspect 14. The packed bed reactor of any previous aspect, further comprising a guard bed fluidly connected to the inlet, wherein the guard bed comprises another at least one catalyst pellet.
Aspect 15. The packed bed reactor of any previous aspect, wherein n=5 or 6.
Aspect 16. The packed bed reactor of any previous aspect, wherein the first polygonal surface and the second polygonal surface comprise rounded corners.
Aspect 17. A method for hydroprocessing a hydrocarbon feed, the method comprising: passing the hydrocarbon feed into a reactor vessel in the presence of hydrogen, such that the hydrocarbon feed contacts a packed catalyst bed to form a product composition, wherein the packed catalyst bed comprises at least one catalyst pellet, and wherein the catalyst pellet comprises: a substantially regular polygonal prismatic body comprising a first polygonal surface, a second polygonal surface opposite the first polygonal surface, and n faces each extending in a length dimension from the first polygonal surface to the second polygonal surface, wherein n is equal to an integer from 5 to 20; and n apertures extending from the first polygonal surface to the second polygonal surface, wherein each aperture has a substantially cylindrical shape, and wherein each aperture is positioned such that it is oriented towards a corner of the first polygonal surface and the second polygonal surface; and passing the product composition out of the reactor vessel.
Aspect 18. The method of any previous aspect, wherein the hydrocarbon feed comprises crude oil and the product composition comprises transportation fuels, light olefins, aromatic compounds, or combinations thereof.
Aspect 19. The method of any previous aspect, wherein n=5 or 6.
Aspect 20. The method of any previous aspect, wherein the first polygonal surface and the second polygonal surface comprise rounded corners.

### EXAMPLES

The various embodiments of the present disclosure will be further clarified by the following examples. The examples are illustrative in nature and should not be understood to limit the subject matter of the present disclosure.

### Example 1-Mathematical Modeling of Surface Area to Volume Ratio

A mathematical model was built to compare the surface area to volume ratio (SVR) of the catalyst pellet described herein with conventional catalyst pellet shapes. The conventional catalyst pellets used were TK-453 and TK-26.

### 4-Lobe Catalyst (Comparative)

A TK-453 SiliconTrap™ catalyst was obtained from Topsoe. The TK-453 catalyst is a 4-lobe catalyst that has a base geometrically consisting of four lobes, which are approximately semicircles, surrounding a square of side length s. The base is extruded to a certain depth h. The surface S of the catalyst was calculated by Formula I. The volume V was calculated by Formula II. The SVR_{4-lobe} was then calculated by Formula III.

$$S = 2 ( {s}^{2} + 2 π {r}^{2} ) + 2 π rh \qquad ( I )$$

$$V = ( {s}^{2} + 2 π {r}^{2} ) h \qquad ( II )$$

$${SVR}_{4 - l o b e} = \frac{2}{h} + \frac{2 π r}{{s}^{2} + 2 π {r}^{2}} \qquad ( III )$$

The commercial parameters of the TK-453 catalyst were measured to be r=1 mm, s=2 mm, and h=5 mm. The SVR_{4-lobe} was calculated to be 1.622 mm⁻¹.

### Spikes Catalyst (Comparative)

A TK-26 TopTrap™ catalyst was obtained from Topsoe. The TK-26 catalyst has a base of a circle with radius R. The circle has three circular apertures with radius r and eight exterior rectangular spikes with length/and width w. The base is extruded to a depth h. The base has an area A calculated by Formula IV, a surface area S calculated by Formula V, and a volume V calculated by Formula VI. The SVRₛₚᵢₖₑₛ was then calculated using Formula VII.

$$A = π ( {R}^{2} - 3 {r}^{2} ) + 8 ℓ w \qquad ( IV )$$

$$S = 2 A + h [ 8 ( 2 ℓ + w ) + ( 2 π R - 8 w ) + 3 ( 2 π r ) ] \qquad ( V )$$

$$V = A h \qquad ( VI )$$

$${SVR}_{spikes} = \frac{2}{h} + \frac{8 ( 2 ℓ + w ) + ( 2 π R - 8 w ) + 3 ( 2 π r )}{π ( {R}^{2} - 3 {r}^{2} ) + 8 ℓ w} \qquad ( VII )$$

The commercial parameters of the TK-26 catalyst were measured to be r=1.5 mm, R=5 mm, l=3 mm, w=1 m, and h=25 mm. The SVRₛₚᵢₖₑₛ was calculated to be 1.51 mm⁻¹.

### Polygonal Pellet of the Present Disclosure

The SVR of a catalyst pellet described herein was calculated. The area A of the base was calculated using Formula VIII, with R as the polygon's circumradius and d as the diameter of the apertures. The volume V was calculated using Formula VI above with h as the height of the pellet. The total surface area S was calculated using Formula IX with n as the number of vertices of the polygon. The SVRₚₚ was calculated using Formula X.

$$A = 0.5 {R}^{2} n sin ( \frac{2 π}{n} ) - \frac{π n {d}^{2}}{4} \qquad ( VIII )$$

$$S = h [ nd sin ( \frac{π}{n} ) + π n d ] + 2 A \qquad ( IX )$$

$${SVR}_{PP} = \frac{S}{V} = \frac{S}{A h} = \frac{n d}{A} ( π + sin ( \frac{π}{n} ) ) + \frac{2}{h} \qquad ( X )$$

As shown in Formula X, the ratio value SVR gets larger as h gets smaller.

TABLE 1
SVR of polygonal pellets with n = 6

| | R | d | h | SVR_{PP} |
|---|---|---|---|---|
| Example | [mm] | [mm] | [mm] | [1/mm] |
| 1 | 4 | 1.75 | 5 | 2.3604 |
| 2 | 3 | 1.75 | 5 | 5.2144 |
| 3 | 3 | 1.5 | 5 | 3.6791 |
| 4 | 4 | 1.5 | 5 | 2.0117 |
| 5 | 3 | 1.75 | 10 | 5.0144 |
| 6 | 4 | 1.75 | 10 | 2.1604 |

As shown in Table 1, the SVR of the catalyst pellet is higher than the SVR_{4-lobe} and SVRₛₚᵢₖₑₛ. The SVRₚₚ can even be over 3 times larger than the conventional 4-lobe catalyst or spikes catalyst, as shown in Example 2. A higher SVR increases the active sites on the surface of the catalyst pellet, thus increasing catalytic activity.

### Example 2-Stress Analysis

A static structural analysis was performed in Ansys Mechanical on three different extruded polygonal prismatic shapes to determine the relative strength of the pellets. A pentagonal prism pellet (as shown in FIG. 1A), a pentagonal prism pellet with rounded corners (as shown in FIG. 3), and a hexagonal prism catalyst pellet (as shown in FIG. 2A) were evaluated. The dimensions of the catalyst pellets are listed in Table 2. The effect of rounding the corners was also evaluated to minimize stresses and reduce abrasion of the catalyst material. A zeolite catalyst was used in the simulation and the material properties are listed in Table 3.

TABLE 2
Dimensions of the Catalyst Pellets

| | Pentagonal | Rounded | Hexagonal |
|---|---|---|---|
| | prism | pentagonal prism | prism |
| R (mm) | 3 | 3 | 3 |
| d (mm) | 1.5 | 1.5 | 1.5 |
| h (mm) | 5 | 5 | 5 |
| n | 5 | 5 | 6 |

TABLE 3
Catalyst Material Properties

| Density (kg/m³) | 750 |
|---|---|
| Young's Modulus (Pa) | 3.5E+11 |
| Poisson's Ratio | 0.18 |
| Bulk Modulus (Pa) | 1.8229E+11 |
| Shear Modulus (Pa) | 1.4831E+11 |
| Isotropic Secant Coefficient of Thermal Expansion | 1.4E−05 |
| (1/° C.) | |
| Compressive Ultimate Strength (Pa) | 9.5E+05 |
| Compressive Yield Strength (Pa) | 0 |
| Tensile Ultimate Strength (Pa) | 80000 |
| Tensile Yield Strength (Pa) | 0 |
| Isotropic Thermal Conductivity (W/m · ° C.) | 0.72 |
| Specific Heath Constant Pressure (J/kg · ° C.) | 780 |

The deformation of each pellet was evaluated with a simulated load of 100 N. The maximum deformation for each pellet is shown in Table 4.

TABLE 4
Deformation of the Pellets

| Catalyst Pellet Shape | Maximum Deformation (mm) |
|---|---|
| Pentagonal prism | 1.30E−05 |
| Rounded pentagonal prism | 1.24E−05 |
| Hexagonal prism | 3.06E−06 |

As shown in Table 4, the hexagonal prism catalyst pellet shape is structurally more rigid than the pentagonal prism catalyst pellet shape. Further, rounding the corners reduces deformation which indicates an improvement of pellet strength.

### Example 3-Influence of Pellet Shape on HDS Activity

The hydrodesulfurization (HDS) activity of conventional catalyst pellet shapes and pentagonal prism catalyst pellet shapes were estimated at 350° C. and 370° C., as shown in Table 5.

TABLE 5
HDS Activity

| | Shape | | | |
|---|---|---|---|---|
| | | 2- | 4- | Pentagonal Prism |
| | Sphere | lobe | lobe | (Example 1) |
| SVR (1/mm) | 1.5 | 1.59 | 1.62 | 2.36 |
| HDS activity, % at 350° C. | 90.0 | 91.5 | 92.1 | 97.9 |
| HDS activity, % at 370° C. | 94.5 | 95.8 | 96.7 | 99.9 |

Table 5 indicates that the HDS activity of a catalyst pellet increases as the SVR increases. The pentagonal prism catalyst pellet was found to have higher HDS activities (97.9% at 350° C. and 99.9% at 370° C.) than the conventional sphere, 2-lobe, and 4-lobe catalysts. Thus, a higher SVR results in greater HDS activity.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the appended claims should be taken as the sole representation of the breadth of the present disclosure and the corresponding scope of the various embodiments described in this disclosure. Further, it should be apparent to those skilled in the art that various modifications and variations can be made to the described embodiments without departing from the spirit and scope of the claimed subject matter. Thus, it is intended that the specification cover the modifications and variations of the various described embodiments provided such modification and variations come within the scope of the appended claims and their equivalents.

For the purposes of describing and defining the present inventive technology it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

As used herein, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

What is claimed is:

1. A catalyst pellet comprising:
a substantially regular polygonal prismatic body comprising:
a first polygonal surface;
a second polygonal surface opposite the first polygonal surface; and
n faces each extending in a length dimension from the first polygonal surface to the second polygonal surface, wherein n is equal to an integer from 5 to 20; and
n apertures extending from the first polygonal surface to the second polygonal surface, wherein each aperture has a substantially cylindrical shape, and wherein each aperture is positioned such that it is oriented towards a corner of the first polygonal surface and the second polygonal surface.

2. The catalyst pellet of claim 1, wherein the first polygonal surface and the second polygonal surface comprise rounded corners.

3. The catalyst pellet of claim 1, wherein n=5.

4. The catalyst pellet of claim 1, wherein n=6.

5. The catalyst pellet of claim 1, wherein the position of the apertures are substantially radially symmetric with respect to the first polygonal surface and the second polygonal surface.

6. The catalyst pellet of claim 1, further comprising a cracking component comprising one or more of zeolite, alumina, or amorphous silica-alumina and a hydrogenation component comprising one or more of molybdenum, nickel, tungsten, cobalt, iridium, platinum, or palladium.

7. The catalyst pellet of claim 1, further comprising from 0 wt. % to 20 wt. % Molybdenum (VI) Trioxide, from 0 wt. % to 30 wt. % of Tungsten (VI) Trioxide, and from 0 wt. % to 8 wt. % of Nickel (II) Oxide.

8. The catalyst pellet of claim 1, further comprising a surface area to volume ratio of greater than or equal to 2 mm⁻¹.

9. The catalyst pellet of claim 1, wherein the apertures have a diameter of from 1 mm to 2 mm.

10. The catalyst pellet of claim 1, wherein the length dimension is from 1 mm to 10 mm.

11. The catalyst pellet of claim 1, wherein the circumradius of the first polygonal surface and the second polygonal surface is from 1 mm to 5 mm.

12. The catalyst pellet of claim 1, wherein the ratio of the width dimension to the length dimension is from 0.1 to 6.

13. A packed bed reactor comprising:
a reactor vessel comprising an inlet and an outlet;
a packed catalyst bed comprising at least one catalyst pellet, wherein the catalyst pellet comprises:
a substantially regular polygonal prismatic body comprising a first polygonal surface, a second polygonal surface opposite the first polygonal surface, and n faces each extending in a length dimension from the first polygonal surface to the second polygonal surface, wherein n is equal to an integer from 5 to 20; and
n apertures extending from the first polygonal surface to the second polygonal surface, wherein each aperture has a substantially cylindrical shape, and wherein each aperture is positioned such that it is oriented towards a corner of the first polygonal surface and the second polygonal surface.

14. The packed bed reactor of claim 12, further comprising a guard bed fluidly connected to the inlet, wherein the guard bed comprises another at least one catalyst pellet.

15. The packed bed reactor of claim 12, wherein n=5 or 6.

16. The packed bed reactor of claim 12, wherein the first polygonal surface and the second polygonal surface comprise rounded corners.

17. A method for hydroprocessing a hydrocarbon feed, the method comprising:
passing the hydrocarbon feed into a reactor vessel in the presence of hydrogen, such that the hydrocarbon feed contacts a packed catalyst bed to form a product composition, wherein the packed catalyst bed comprises at least one catalyst pellet, and wherein the catalyst pellet comprises:
a substantially regular polygonal prismatic body comprising a first polygonal surface, a second polygonal surface opposite the first polygonal surface, and n faces each extending in a length dimension from the first polygonal surface to the second polygonal surface, wherein n is equal to an integer from 5 to 20; and
n apertures extending from the first polygonal surface to the second polygonal surface, wherein each aperture has a substantially cylindrical shape, and wherein each aperture is positioned such that it is oriented towards a corner of the first polygonal surface and the second polygonal surface; and
passing the product composition out of the reactor vessel.

18. The method of claim 15, wherein the hydrocarbon feed comprises crude oil and the product composition comprises transportation fuels, light olefins, aromatic compounds, or combinations thereof.

19. The method of claim 15, wherein n=5 or 6.

20. The method of claim 15, wherein the first polygonal surface and the second polygonal surface comprise rounded corners.
